(19) United States
(12) Patent Application Publication
(10) Pub. No.: US 2011/0073676 A1
(43) Pub. Date: Mar. 31, 2011

(54) PRODUCTION OF A SOLIDS-CONTAINING PUR SPRAY JET

(75) Inventors: Hans-Guido Wirtz, Leverkusen (DE); Andreas Frahm, Leverkusen (DE); Frithjof Hannig, Duesseldorf (DE); Stephan Schleiermacher, Pulheim (DE)

(73) Assignee: Bayer MaterialScience AG, Leverkusen (DE)

(21) Appl. No.: 12/994,983

(22) PCT Filed: May 19, 2009
(86) PCT No.: PCT/EP09/03545

§ 371 Date: Nov. 29, 2010

(30) Foreign Application Priority Data
May 28, 2008 (DE) 10 2008 025 523.8

(51) Int. Cl. B05B 7/26; C08L 75/04; B05D 1/02

(52) U.S. Cl. 239/310; 524/871; 427/427.4

(57) ABSTRACT

The present invention relates to a process for producing a solids-containing PUR spray jet and also to a spray attachment, wherein a solids-containing gas stream is introduced into a liquid jet of a PUR reaction mixture.

The present invention relates to a process for preparing a solids-containing PUR spray jet, and to a spray attachment.

Two different approaches are described in the prior art for preparing solids-containing PUR composite materials:

A process currently in use for incorporating solids into a polyurethane spray jet atomized by pressurized gas is the lateral injection of the particles through one or more supply installations mounted outside the mixing head. Under ideal conditions and mutual matching of the flow rates, the introduced solids jet is broken up in the center of the polyurethane spray jet, which causes sufficient wetting and distribution of the solids particles.

In both methods, the spraying supported by pressurized gas and the particle injection, the gas flow rate is a critical parameter for the function. When the two methods are combined, the gas streams influence each other, so that only a compromise can be reached in the optimum case.

Effects of the insufficient adjusting possibilities include a borderline-type wetting or distribution of the solid particles in the polyurethane spray jet while the solids loss is high in part.

In the first variant, the solids to be used are mixed with one of the two polyurethane components, normally the polyol component, and the thus obtained solids-component mixture is employed for the preparation of a solids-containing PUR composite material. Examples in this context include DE 39 09 017 C1 and DE 40 10 752 A1, in which the preparation of polyurethane flexible foams containing expandable graphite or expandable graphite/melamine is described.

However, such an approach is associated with various disadvantages. Thus, for example, a general problem in the use of solids results from the fact that they are usually not soluble in the polyol component. This has the effect that the dispersion of the polyol component and the solid must be constantly stirred in order to avoid sedimentation of the solid in the storage tank and to ensure a homogeneous distribution of the solid within the composite material. Melamines, for example, additionally have the undesirable property to “bake together” rather quickly after sedimentation to form a cake, which makes the redispersion of the solid substantially more difficult.

Also, solids having very different specific weights (based on the carrier liquid), such as wood flour or glass bubbles, are difficult to process by this method. Such solids usually tend to float upwards in the storage tank and, in the case of wood flour, also to swelling.

In addition, the presence of the solid in the liquid polymer component changed the physical properties, for example, the viscosity as compared to the pure polyol component, which adversely affects the miscibility of the reaction components.

The processing of such systems is possible only on machines specifically constructed for this purpose, which in turn causes higher production cost. In addition, when high-pressure mixing heads are used in the processing of polyurethane raw materials, very high shear forces occur in the nozzles of the mixing heads, under which the solid particles, such as expandable graphite, are severely affected and thus can at least partially lose their desired activity.

The second variant for preparing solids-containing PUR composite materials is the injection method, in which a solids-containing gas stream is introduced into a PUR spray jet.

In this variant, the solids are supplied to the spray jet. The addition of the solids is preferably effected through one or more external supply installations laterally mounted onto the spray mixing head, wherein the solids are laterally introduced into the spray jet, preferably with the aid of pressurized gas. When solids having a low specific weight were used, this method could not meet the increasing demands regarding the uniformity of the distribution.

Within the meaning of the present invention, “PUR spray jet” means a jet that essentially consists of fine particles (droplets) of a PUR material, i.e., of a mixture of at least one polyol component and at least one isocyanate component, dispersed in a gas stream.

Such a PUR spray jet can be obtained in different ways, for example, by atomizing a liquid jet of a PUR material by a gas stream introduced into it, or by the ejection of a liquid jet of a PUR material from a corresponding (atomizer) nozzle.

Such methods are described, for example, in DE 10 2005 048 874 A1, DE 101 61 600 A1, WO 2007/073825 A2, U.S. Pat. No. 3,107,057 and DE 1 202 977 B. One peculiarity of the methods described in the latter two documents is the fact that the injection of the solids-containing gas stream into the PUR spray jet is effected in a separate chamber directly downstream from the ejection site of the PUR spray jet. This additional hollow/mixing chamber is supposed to improve the mixing of the PUR spray jet with the solid particles.

However, in all methods following the second alternative as described above for preparing a solids-containing PUR spray jet, it must be noted that the wetting of the solids particles employed is still not as uniform as would be desirable. Among others, this is due to the fact that sizes and masses of the solid particles vary, whereby the behavior during the injection into the spray jet is changed. In part, very high losses of the solid particles employed are observed.

Therefore, it is an object of the present invention to provide a process for preparing a solids-containing PUR spray jet that avoids the above described drawbacks of the prior art. In particular, it is an object to provide a process that enables a more uniform wetting of the solid while there is a lower solids loss or even none at all.

The object of the present invention is achieved by a process for preparing a solids-containing PUR spray jet, characterized in that a solids-containing gas stream is injected into a liquid jet of a PUR reaction mixture.

Thus, an essential difference of the present invention as compared to the prior art, especially the second variant, is the fact that the solids-containing gas stream is not injected into the already dispersed spray jet of the reaction mixture, but into the still liquid, undispersed jet in the mixing chamber. Here, the flow of the reaction mixture is still essentially laminar in nature.

According to the invention, a “liquid jet of a PUR reaction mixture” means a fluid jet of a PUR material, especially in the range of the mixing chamber for mixing the reaction components in liquid form, that is not yet in the form of fine reaction mixture droplets dispersed in a gas stream, i.e., especially in a liquid viscous phase. Thus, in particular, such a “liquid jet of a PUR material” does not mean a PUR spray jet as described above.

Thus, while the processes of the prior art according to the above described second alternative essentially use a gas stream or a corresponding nozzle for atomizing a PUR reaction mixture, and another, solid-containing gas stream is injected into such an atomized PUR spray jet, the process of the present invention is characterized in that a solids-containing gas stream in a spray-mixing nozzle is employed for atomizing a liquid jet of a PUR reaction mixture on leaving this mixing chamber.

By the process according to the invention, the solids are mixed without loss with the PUR reaction mixture inside the spray nozzle and forcibly wetted to obtain a homogeneous gas/solids/PUR material mixture.

In spray methods using atomization by pressurized gas, high gas flow rates are employed due to process requirements, which enables the solids to be transported by dilute phase conveying (for example, 10 to 40 m/s) when the pressurized gas lines are accordingly dimensioned and implemented. Due to a high conveying rate with a low charging ratio, there is hardly any contact between the individual particles, whereby the formation of agglomerates is prevented and a transfer of the gas/solids mixture into the spray-mixing nozzle is possible without problems when the interface is implemented accordingly. Solids having good flowing properties or low tendencies to agglomerate formation, such as glass bubbles, can be conveyed by dense phase conveying (for example, 3 to 10 m/s) with significantly lower flow rates, whereby the wear of the solids-loaded gas-bearing lines and components is highly reduced. The amount of pressurized gas necessary for the spray process is supplied to the solids stream only immediately upstream of the spray-mixing nozzle when using dense phase conveying.

Within the meaning of the present invention, “solids” essentially means those compounds and substances that are in a solid state of matter at the temperature employed for the process, for example, solids having a relatively high density, commonly referred to as fillers, fibrous solids, such as glass or carbon fibers, or recyclates in powder form as well as flame-retardant solids, such as expandable graphite, melamine and ammonium sulfate. However, the term “solids” also includes those having a low density, i.e., a lower specific weight, as defined in the introduction to the description.

Therefore, it is preferred to inject the solids-containing gas stream through a spray nozzle with a mixing function into a liquid jet of a PUR reaction mixture. In addition, it is preferred if the solids-containing gas stream of the spray-mixing nozzle is supplied through a pressurized air supply line.

When the process according to the invention was developed, it has been found that spray-mixing heads with one or more pressurized air supply lines of the prior art may also be used satisfactorily.

The process according to the invention is particularly cost-efficient since retrofittings of commercially available PUR spray machines using pressurized air atomization achieve filler-suitability with slight modifications, the supply quantities being limited by the gas flow rate.

The solids-containing gas stream is preferably prepared by passing a gas stream through solids-containing metering cells of a cellular wheel sluice. By the flushing of the cellular spaces, the solid is dragged along by the pressurized air stream and transported to the mixing chamber/mixing head as a solid/air or solid/gas mixture. To avoid pulsation, the channel inside the metering sluice must be designed with a diameter that excludes positive overlap. This embodiment further ensures that a quantitatively unchanged air flow rate for spraying the PUR reaction mixture is available even when the cellular wheel sluice metering is turned off of its revolutions per minute is changed, and thus spraying can be effected alternatively without or with variable filler quantities. As a particular advantage of such a cellular wheel sluice, the solids proportion in the PUR composite material to be prepared can be variably adjusted.

In a particular embodiment of the process using a cellular wheel sluice, the gas stream and the solids storage tank may be interconnected through a pressure equalizer.

It has been found that a particularly reproducible metering of the solids fraction in the PUR composite material to be prepared can be achieved by such an injection of the solid into the gas stream without a pressure difference according to the possibilities described above. For a reproducible solids supply by flushing the metering cells and dragging the solids into the air stream, a loose packing in the metering cells is to be preferred.

The supply of the solids without a pressure difference prevents the densification of the solids packing when entering the gas stream.

Further, the pressure equalization prevents that partial streams of the transport air escape back through the metering aggregate (metering cells and gap tolerances) into the storage tank. For abrasive solids, in particular, larger gap dimensions are unavoidable due to construction requirements.

Other solids metering principles, such as metering through devices with conveying disks or through powder pumps, are also possible. However, the previously described cellular wheel metering is characterized by avoiding the formation of agglomerates.

Further, it is preferred to control the production of the solids-containing gas stream in such a way that the solid becomes homogeneously distributed in the gas stream upon injection of the solids-containing gas stream into the liquid jet of a PUR reaction mixture.

In both dense phase and dilute phase conveying, the maximum possible volume ratio of gas to solid when entering the spray-mixing nozzle is preferably within a range of from 20:1 to 200:1, more preferably from 50:1 to 100:1.

This can be achieved, for example, by changing the solids supply rate.

Further, it is preferred to use nitrogen or especially air as the gas. These gases are particularly inexpensive and thus contribute to a corresponding cost reduction in the process according to the invention.

Expandable graphite, in particular, is employed as the solid in the process according to the invention. In this way, PUR composite materials modified with expandable graphite can be obtained, which are currently of great interest due to their flame-retardant properties, in particular. Other possible solids include, for example, barium sulfate, calcium sulfate, chalk, melamine or wood flour, or powdered PUR scraps.

Another embodiment of the present invention is a spray attachment for injecting a gas stream into a jet of a liquid PUR raw material, comprising

a) a spray channel through which the jet of the PUR raw material flows;
b) at least one gas channel through which the gas stream flows, leading into the spray channel through an entrance port;
characterized in that
the direction of flow of the gas stream when entering the spray channel runs outside the center of the spray channel.

After leaving the PUR mixing head, the jet of the liquid PUR raw material is continued in the spray channel of the spray attachment. Thus, the spray channel preferably has the same diameter as the mixing chamber in the PUR mixing head. However, it may also have smaller or larger diameters. Preferably, the spray channel has a tubular design, its longitudinal axis preferably being located on the same straight line as the longitudinal axis of the mixing chamber of the PUR mixing head.

The entrance ports for the gas stream entering the spray channel are preferably provided close to the transition from the PUR mixing head to the spray attachment, i.e., at the beginning of the spray channel (as in the direction of flow).

Both the “direction of flow of the gas stream” and the “direction of flow of the PUR raw material” as discussed below are to be understood in a vectorial sense, wherein the lengths of the respective vectors are proportional to the respective flow rates, and their direction is parallel to the direction of flow of the gas stream or of the PUR raw material, respectively. Due to the design of the entrance port or of the spray channel, which is not a straight line or a point, the exact position in space of these vectors is defined in such a way that the direction of flow of the gas stream does not run through the center of the entrance port or of the spray channel.

The orientation of the direction of flow of the gas stream when entering the spray channel as described above includes all possible arrangements of entrance ports into the spray channel, except for those in which the direction of flow of the gas stream runs exactly through the center of the spray channel.

Preferably, the direction of flow of the gas stream when entering the spray channel runs through the spray channel at a distance y of 0.8·r≦y≦r from the center of the spray channel, where r represents the radius of the spray channel. In other words, the direction of flow of the gas stream when entering the spray channel is arranged generally tangentially to the border surrounding the spray channel. In this connection, it should be obvious that a 100% tangential arrangement of the direction of flow of the gas stream when entering the spray channel with respect to the border surrounding the spray channel cannot be realized because the design of the entrance port is not point-like; nevertheless, it is clear in this context what “generally tangential” is supposed to mean. This becomes even clearer in the discussion of FIGS. 1 to 4.

The generally tangential arrangement provides the axial flow component, i.e., the direction of flow of the PUR material, with a rotational component (spin). This arrangement serves for the optimum distribution and mixing of the solid/liquid-gas mixture with the liquid jet of the PUR material.

Further, it is preferred that the device according to the invention has several gas channels, especially an even number of gas channels, whose gas streams can be changed independently of one another. “Can be changed independently of one another” within the meaning of the present invention may refer to either the direction of flow of the gas stream when entering the spray channel, or the flow rate of the gas stream, or the actual composition of the gas stream, for example, with respect to solids or liquids contained therein. An even number of gas channels is preferred because a process variant that is particularly gentle to the material of the spray attachment can be realized thereby.

Due to the fact that the gas streams can be changed independently of one another, a particle transport in the form of “dilute phase conveying” (>20 m/s) can be ensured. Because of the high conveying rate at a low loading ratio (official definition of dilute phase conveying: for example, ≦15 kg/kg), there is only little contact between the individual particles, which prevents the formation of agglomerates.

If two gas channels are used, their entrance ports are preferably located on a straight line, and if more than two gas channels are used, their entrance ports are preferably located in a plane, that are respectively arranged vertically to the direction of flow of the PUR material in the spray channel.

Further, it is preferred that the diameter of the gas channel decreases in the direction of flow of the gas stream, especially shortly before it enters the spray channel.

This measure increases the flow rate, prevents the gas-solid/liquid mixture from flowing back into the gas channel, and enhances the intensity of the rotation effect in the spray channel. The gas flow rates should be matched in such a way that comparable flow rates prevail in the respective gas channels. In this method, the usual supply quantities of the spray attachments are from 1.5 to 5 dm³ of gas per second.

In this connection, it is preferred that the ratio of the cross-sectional area of the entrance port to the cross-sectional area of the gas channel be within a range of from 1:8 to 1:40 at its widest part, i.e., the cross-sectional area of the gas channel is tapered towards the outlet (entrance port).

The entrance port/s preferably has/have a cross-sectional area within a range of from 1 to 4 mm². The value of the cross-sectional area of the entrance port is usually determined experimentally, since surface structures and particle geometries are responsible for the conveying characteristics, in addition to the particle size. As a guide value, a diameter of 3.3×equivalent diameter may be assumed.

Preferably, the direction of flow of the gas stream and the direction of flow of the PUR material (i.e., the corresponding vectors, cf. above) form an angle of from 110 to 115°.

More preferably, the direction of flow of the gas stream undergoes a deflection by an angle of from 5 to 10°, preferably of 7.5°, towards the direction of flow of the PUR material before the gas stream enters the spray channel, especially shortly before it enters the spray channel. Experiments have shown that expandable graphite plates exhibit a significantly better behavior of entry into the jet of the liquid PUR material due to this measure/these measures. Centrifugal forces cause a deflection and condensation of the particle jet. By the simultaneous increase of the flow rate and the streamlined particle orientation, solids of larger diameter can also be conveyed in this way through the gas outlets tapered in the direction of flow without obstruction phenomena.

In another embodiment, the spray attachment according to the invention is characterized by being combined with a high-pressure mixer or a low-pressure mixer.

Those components of the spray attachment that come into contact with the optionally solids-loaded gas stream are preferably made of a tear-resistant material, especially aluminum oxide, tungsten carbide, silicon carbide and/or boron carbide.

It is further preferred that the gas channel be formed by a two-piece insert, especially an insert of a tear-resistant material. The material abrasion in both the gas channel and the spray channel is clearly reduced by these measures.

Alternatively, the two-piece insert may also be formed from a less tear-resistant material; in this case, there is preferably a ceramic disk between the lower and upper components, especially a ceramic disk made of a tear-resistant material that covers the gas channels at the top and thus functions as the actual deflection component for the particle-loaded gas stream.

### EXAMPLES

PUR systems as are used, for example, for insulators, cable ducts and for floor sealing. Here, solids can be employed, for example, for a better flame retardant property, better demoldability, better electric insulation, or improved mechanical properties.
Hot casting systems, i.e., solid and foamed elastomers as are used, for example, in dampers or wheels of forklifts. When the processing by the above described process is used, solids can be employed, for example, for a better flame retardant property, better demoldability, lesser abrasion, better electric conductivity, a variation of the spring characteristic, or improved mechanical properties.
Elastic and rigid spray skins employed for preparing wear-inhibiting layers on simply profiled large-area metal parts, for example, silos, bulk containers, conveying troughs or tubes, for manufacturing water-impermeable layers in civil engineering, for example, roof and bridge sealing, for preparing elastic molds,
for the insulation of tubes with syntactic foam, as a fire-protection layer for, for example, containers, or as an outer skin/protection layer of molded parts, for example, seat foams as well as sound absorption parts. Here, solids can be employed, for example, for a better flame retardant property, better electric conductivity, better demoldability, improved mechanical properties, a lower coefficient of linear thermal expansion, a higher density, or a lower abrasion.
Flexible (molded) foams applied by spraying as occur, for example, in seat or molded foams for applications in private and public spaces and in passenger traffic, such as seating for buses, trains, ships, aircrafts, cars, theaters, cinemas, furniture and (hospital) beds. Here, solids can be employed, for example, for a better flame retardant property, better electric conductivity, better demoldability, increased or decreased water absorption, improved mechanical properties, better sound absorption, or lesser abrasion.
Flexible (molded) foams applied by spraying as employed, for example, as sealing and filtering foams, for example, in the automobile industry. Here, solids can be employed, for example, for a better flame retardant property, better electric conductivity, better demoldability, improved mechanical properties, or lesser abrasion.
Rigid foams applied by spraying as employed, for example, in the insulation of tubes, in metal composite panels, refrigerators, tanks, reactors or hot-water storage tanks. Here, solids can be employed, for example, for a better flame retardant property, better bonding to the substrate, better electric conductivity, better thermal resistance and insulation, and improved mechanical properties.
Semi-rigid foams applied by spraying as employed, for example, for instrument panels, door interior trims or roof liners. Here, solids can be employed, for example, for a better flame retardant property, better bonding to the substrate, better electric conductivity, improved mechanical properties, increased or decreased water absorption, improved acoustic properties, or improved thermal properties.
Spray foams as employed for the insulation of cold stores, buildings, tanker trucks, tank wagons, liquid gas tanks, ships, sea containers, intermediate bulk containers and aircrafts. Here, solids can be employed, for example, for a better flame retardant property, better bonding to the substrate, better electric conductivity, better thermal resistance and insulation, and improved mechanical properties.
Flexible and rigid integral foams applied by spraying as employed for protectors, armrests, headrests, furniture, housings of electric appliances, ski cores, decorative elements or trim parts of vehicles. Here, solids can be employed, for example, for a better flame retardant property, better electric conductivity, increased or decreased water absorption, improved mechanical properties, better demoldability, a lower coefficient of linear thermal expansion, or a lower abrasion.
Filler foams applied by spraying as employed, for example, for the cavity sealing or stiffening of component parts. Here, solids can be employed, for example, for a decreased water absorption, better bonding to the substrate, or improved mechanical properties.
Fire-resistant paints or colored paints applied by spraying, in which the fire-proofing agents or the color pigments can be directly supplied to any basis paint by the process as described above.
One- and two-part adhesive in which mechanical properties and thixotropic behavior can be individually adjusted selectively and locally by supplying solids.
Fillers applied by spraying as employed, for example, for the surface smoothing of hand laminates, laminates prepared by SMC, BMC and RTM techniques. Here, solids can be employed, for example, for a better flame retardant property, better electric conductivity, improved paint adherence, improved grindability, improved mechanical properties, a lower coefficient of linear thermal expansion, a higher density, or a lesser abrasion.
Elastic and rigid spray skins for the seamless preparation of radiation-screening layers, for example, floor sealing for holding back radioactive liquids.

The size of the solid particles to be incorporated is of some importance. It is particularly preferred that the size of the particles be up to 1 mm.

Further, the process according to the invention is preferably performed by spraying a solids-containing PUR spray jet as described above into an open mold or onto substrate supports.

FIGS. 1 to 4 show the spray attachment according to the invention and the use thereof in association with a matching mixing head.

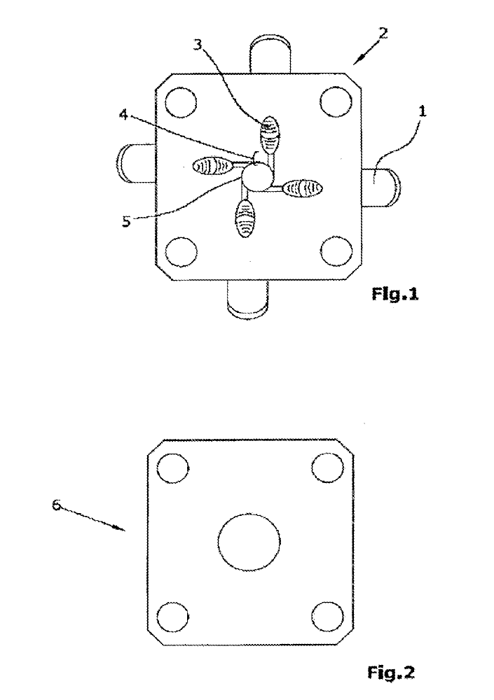

FIGS. 1 and 2 illustratively show a spray attachment consisting of two parts, namely components 2 and 6 as represented in FIGS. 1 and 2. FIG. 1 shows the lower part 2 of the spray attachment. The gas channels can be supplied with gas or solids mixture through the inlets 1; they are continued through the component part to its surface that is visible in FIG. 1. Since the gas channels run obliquely within the component part, they appear in elliptic shape at the surface of component part 2. Starting from this gas channel 3, a passage 4 with a lower diameter leads to the spray channel 5. It can be seen that the gas stream entering at 1 and leaving at 3 undergoes a deflection (which is preferably by an angle of from 5° to)10° when hitting the cover if the channels 3 and passages 4 are covered, for example, with a ceramic cover disk. Within the tapered gas passage 4, the supplied gas stream undergoes an increase of the flow rate.

FIG. 2 shows an upper cover component 6 for the lower part of spray attachment 2 (after the mounting is complete, it is located between the lower part of spray attachment 2 and the mixing head).

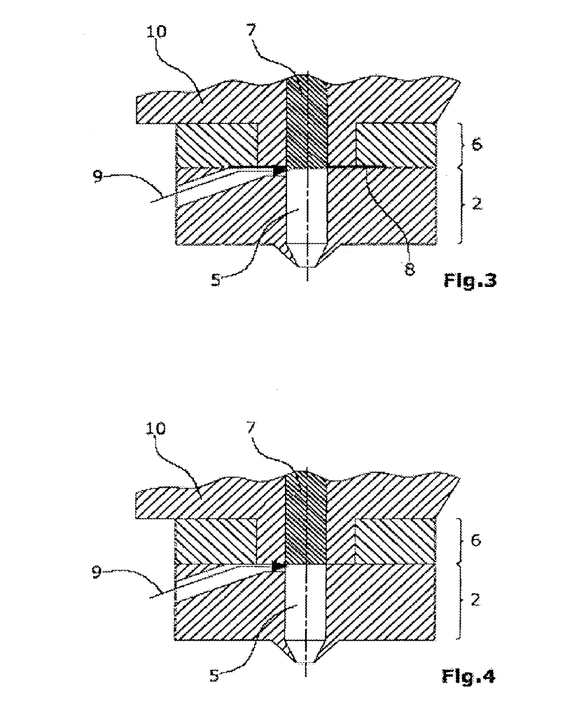

FIGS. 3 and 4 show the spray attachment according to the invention, again consisting of the two components 2 and 6, in connection with a PUR high pressure mixing head 10.

FIG. 3 shows how the gas channels 3 and gas passages 4 as shown in FIG. 1 are covered by the ceramic cover disk 8, so that the gas stream 9 passing through the gas channels 3 undergoes a deflection by an angle of 5° to 10° when it hits the ceramic disk 8. In the embodiment shown, the ratio of the diameter of the spray channel inlet to the inner diameter of the mixing head outlet is 1:1. Also shown is a ram 7, which serves to clean the mixing head channel.

The embodiment shown in FIG. 4 essentially corresponds to the embodiment shown in FIG. 3, except that no ceramic cover disk 8 is provided. In this case, the inserts 2 and 6 are preferably made of a wear-resistant material.

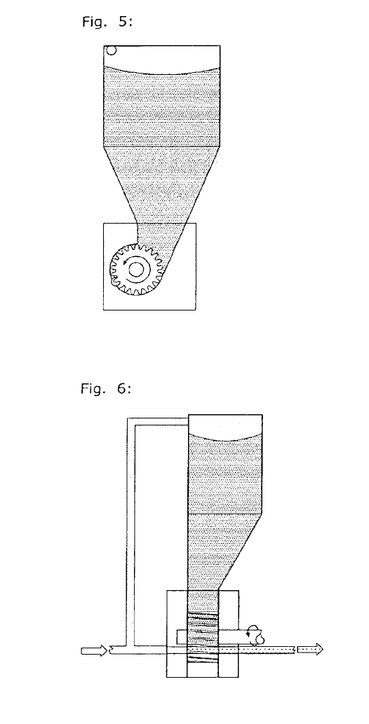

FIG. 5 shows a cellular wheel sluice in a lateral view. As shown, the diameter of the channels within the cellular wheel of the cellular wheel sluice is smaller than the diameter of the channel through which the gas is ducted to the cellular wheel sluice.

FIG. 6 shows the cellular wheel sluice from FIG. 5 in a lateral view. The pressure equalizer, which connects the solids storage tank and the gas stream leading to the solids storage tank, is shown.

### EXAMPLE

The object of the following Example was the incorporation of expandable graphite into a PUR spray jet to produce a flame-retardant PUR layer. The sought amounts of solids were around 20 percent by weight, based on the PUR discharge.

Discharge of reaction mixture:
50 g/s (density of mixture 1.088 g/cm³)

Discharge of solid:
10 g/s of expandable graphite
(density 1.5 g/cm³)

Mean particle size of solid:
600 μm

Mixing principle:
High-pressure mixing by countercurrent
injection in a commercially available PUR
spray system

Amount of spray air:
2.5 dm³/s

Diameter of spray nozzle:
5 mm

Description of starting materials:

The following polyols, either pure or in the form of different mixtures, as well as stabilizers, activators and polyisocyanate components are employed.

Polyol 1: a commercially available trifunctional PO/EO polyether with 80 to 85% of primary OH groups and an OH number of 28.

Polyol 2: a commercially available trifunctional PO/EO filled polyether (filler: polyurea dispersion, about 20%) with an OH number of 28.

Polyol 3: a commercially available trifunctional PO/EO polyether with 83% of primary OH groups and an OH number of 37.

Stabilizer: Tegostab® B 8629, polyether polysiloxane copolymer from the company Evonik Goldschmidt GmbH.

Activator 1: Bis(2-dimethylaminoethyl)ether, dissolved in dipropylene glycol, for example, Niax A 1 from the company Air Products.

Activator 2: Tetramethyliminobis(propylamine), for example, Jeffcat® Z 130 from the company Huntsman.

Polyisocyanate: A prepolymer with an NCO content of about 30%, prepared on the basis of 2-ring MDI and its higher homologues and a polyether with an OH number of 28.5 and a functionality of 6.

Functional principle:

The functional principle of the spray attachment is based on compressed-air atomization. The spray air was injected by means of 4 tangential grooves through an attachment downstream of the mixing chamber located in the mixing head. The grooves were supplied through a circumferential annular groove, which was in turn fed through a compressed-air network. The exiting reaction mixture was accelerated in the outlet part of the spray attachment by the added air and additionally atomized to a spray jet by the spin produced by the tangential grooves (FIG. 1).

Modification:

Due to centrifugal forces, the injection of the gas/solid mixture through the circumferential annular groove can lead to a separation of the solids, which causes obstruction of the clearly smaller tangential grooves, or an irregular solids injection.

By an individual supply of the tangential grooves without deflections through the circumferential annular groove, injection of the gas/solid mixture with a homogeneous distribution could be achieved (FIG. 2).

In the example described, only one of the four tangential grooves was used for injecting the gas/solid mixture, wherein the cross section was extended to the necessary diameter of 2 mm. The remaining grooves could be used as they are for injecting pure spray air. If needed, the solids supply can be effected through several metering devices or different grooves. Such an arrangement provides the possibility of processing higher discharge amounts or different solids that can be switched on according to need.

The air flow rate of all grooves was adjusted under consideration of constant flow rates.

1. A process for preparing a solids-containing PUR spray jet, characterized in that a solids-containing gas stream is injected into a liquid jet of a PUR reaction mixture.

2. The process according to claim 1, characterized in that said injection is performed in a spray-mixing nozzle.

3. The process according to claim 2, characterized in that the solids-containing gas stream is supplied to said spray-mixing nozzle via a gas supply line.

4. The process according to any of claims 1 to 3, characterized in that the solids-containing gas stream is prepared by incorporating the particles into the gas stream by means of a solids metering system.

5. The process according to claim 4, characterized in that the solids content can be adjusted variably.

6. The process according to any of claims 1 to 5, characterized in that the production of the solids-containing gas stream is controlled in such a way that the solid becomes homogeneously distributed in the gas stream upon injection of the solids-containing gas stream into the liquid jet of a PUR reaction mixture.

7. The process according to any of claims 1 to 6, characterized in that nitrogen or especially air is used as the gas.

8. The process according to any of claims 1 to 7, characterized in that expandable graphite is used as the solid.

9. A process for preparing PUR molded parts, characterized in that a solids-containing PUR spray jet according to any of claims 1 to 8 is sprayed into an open mold or onto a substrate support.

10. A spray attachment for injecting a gas stream into a jet of a liquid PUR raw material, comprising
a) a spray channel through which the jet of the PUR raw material flows;
b) at least one gas channel through which the gas stream flows, leading into the spray channel through an entrance port;
characterized in that
the direction of flow of the gas stream when entering the spray channel runs outside the center of the spray channel.

11. The spray attachment according to claim 10, characterized in that the direction of flow of the gas stream when entering the spray channel runs through the spray channel at a distance 0.8·r≦y≦r from the center of the spray channel, where r=radius of the spray channel and y=distance of the direction of flow of the gas stream from the center of the spray channel.

12. The spray attachment according to either of claims 10 or 11, characterized by comprising several gas channels, especially an even number of gas channels, whose gas streams can be changed independently of one another.

13. The spray attachment according to claim 12, characterized in that the entrance ports of the gas channels are located on a straight line or in a plane that is arranged vertically to the direction of flow of the PUR material in the spray channel.

14. The spray attachment according to any of claims 10 to 13, characterized in that the diameter of the gas channel decreases in the direction of flow of the gas stream, especially shortly before it enters the spray channel.

15. The spray attachment according to claim 14, characterized in that the ratio of the cross-sectional area of the entrance port to the cross-sectional area of the gas channel is within a range of from 1:8 to 1:40 at its widest part.

16. The spray attachment according to any of claims 10 to 15, characterized in that the entrance port has a cross-sectional area within a range of from 1 to 4 mm².

17. The spray attachment according to any of claims 10 to 16, characterized in that the direction of flow of the gas stream and the direction of flow of the PUR raw material form an angle of from 110 to 115°.

18. The spray attachment according to any of claims 10 to 19, characterized in that the direction of flow of the gas stream undergoes a deflection by an angle of from 5 to 10°, preferably of 7.5°, towards the direction of flow of the PUR material before the gas stream enters the spray channel, especially shortly before it enters the spray channel.

19. The spray attachment according to any of claims 10 to 18, characterized in that the spray attachment is combined with a high-pressure mixer or a low-pressure mixer.
